(19) United States
(12) Patent Application Publication
(10) Pub. No.: US 2005/0038711 A1
(43) Pub. Date: Feb. 17, 2005

(54) Method for advertising for sale classroom materials and services

(76) Inventor: Merwin Marlelo, Lewis Center, OH (US)

Correspondence Address: MERWIN MARCELO, 7022 ROESPARK BLVD, LEWIS CENTER, OH, 43035, US

(21) Appl. No.: 10/640,287

(22) Filed: Aug. 13, 2003

(51) Int. Cl. G06F 17/60

(52) U.S. Cl. 705/26

(57) ABSTRACT

A method for advertising for sale classroom materials and services such as textbooks, laboratory tools, class notes and tutoring over a communication network. The classroom materials and services are linked to specific courses or classes offered by a particular school. Students would then be able to sell their used textbooks, lab tools, class notes and tutoring service to fellow students at the same school allowing for quicker transactions.

### BACKGROUND OF THE INVENTION

The present invention relates to a method for advertising for sale classroom materials and services to students who are taking or about to take a specific course/class at a school. In particular, the present invention relates to a method for advertising over a web site on the Internet classroom materials such as required textbooks, laboratory tools, class notes and tutoring services offered for sale by students at the school.

College or university students are typically required to buy certain textbooks for the courses that they are enrolled in. These textbooks can be bought either in new or used condition at the bookstores. In some cases, other students who have previously taken the class may sell their textbooks to the students about to take the class. Such used textbooks are typically advertised on bulletin boards or newspapers, both of which are not convenient since a student looking for these books must spend considerable time sorting through bulletin boards and newspapers for the right information.

A student may also sell their used books over the internet using a website. One such site, ScrewTheBookstore.com, allows the student to offer their used textbooks to other students. However, at this time, the site only allows students looking for used textbooks to search the entire database for these books using the book's title, author, or ISBN number.

There is a need to conveniently associate used textbooks to specific courses/classes taught by specific professors at a school in order for students looking for these textbooks to find them quickly.

In addition, students who have previously taken the specific course/class may wish to sell any laboratory tools that they have purchased for the course/class. Further, a good student may want to sell their class notes and to offer tutoring services to student who are taking or about to take the specific course/class.

### SUMMARY OF THE INVENTION

The invention is a method for advertising classroom materials and services associated with a specific course/class at a school over a communication network. A site on the network can be accessed nationally, but will have a page dedicated to a particular school. The school can be a college, university, high school, private school, community school, government agency, museum, or any other entity that offers classes in any course. Classroom materials and services include textbooks (whether required or suggested), laboratory tools, class notes (including notes, outlines, homework exercises, quizzes, tests and handouts), tutoring services, and other academic materials and services related to the specific course/class. Using the invention, students would be able to sell their used textbooks, lab tools, class notes, and tutoring services to fellow students at the same school, allowing for quicker transactions. The site will include a page containing the specified school's required textbooks for its courses/classes. This will allow both sellers and buyers to determine whether the books will be used for the current and/or following quarter or semester.

### BRIEF DESCRIPTION OF THE DRAWINGS

FIG. 1 shows the system for accessing the site.

FIG. 2 shows the flow diagram for accessing the site.

FIG. 3 shows the flow diagram for selling on the site.

FIG. 4 shows the flow diagram for buying on the site.

FIG. 5 shows an example page on the site.

### DETAILED DESCRIPTION

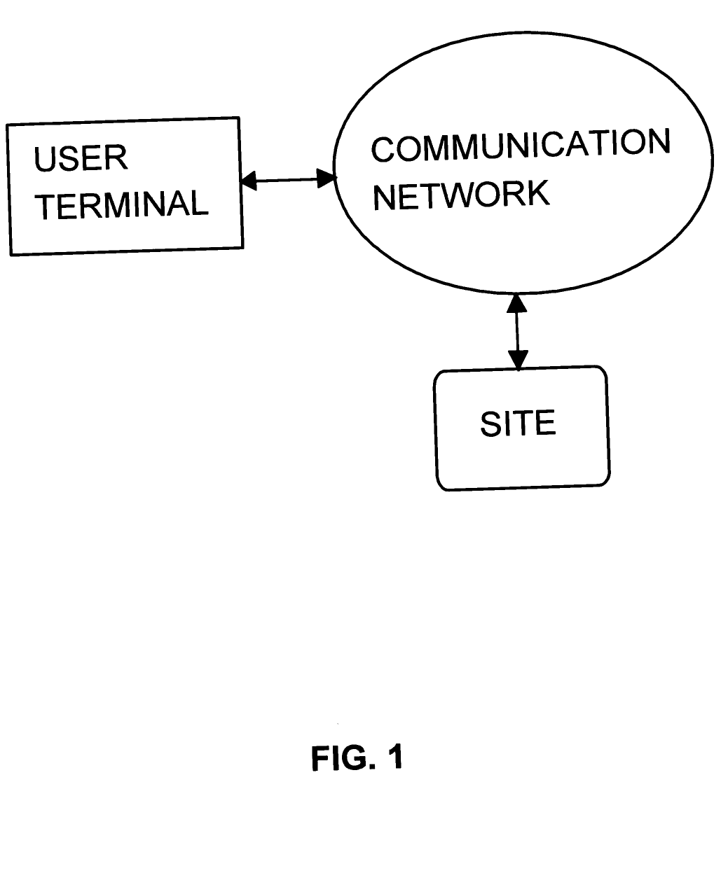

FIG. 1 shows a network for practicing the invention. A user terminal accesses the site over a communication network. The user terminal can be a personal computer (PC) such as a desktop computer or laptop computer, a pda, a cell phone or any other device that transmits and receives data. The communication network can be a Local Area Network (LAN), Wide Area Network (WAN), wireless network, wired network, Public Switched Telephone Network (PSTN), intranet, extranet, or Internet. The user terminal can connect to the communication network using Ethernet, dial-up, DSL, cable, satellite, wireless, wired or any other connecting system. The site can be located anywhere on the network. In one embodiment, the user terminal is a PC that accesses a web site hosted by a server over the Internet. The web site can be created by any web site tool such as Microsoft FrontPage.

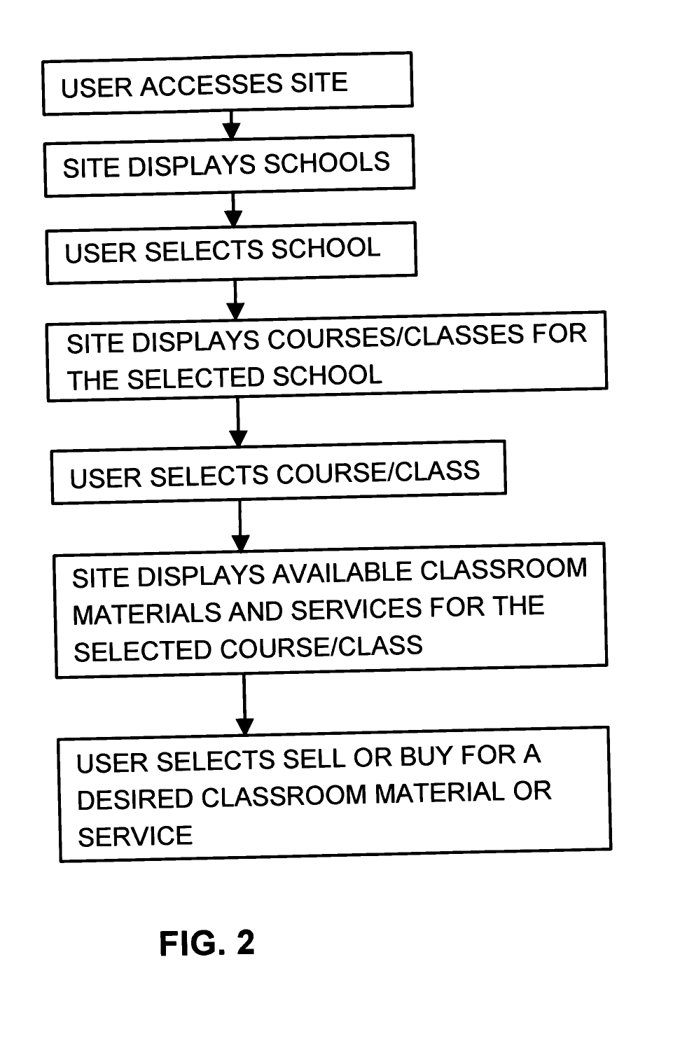

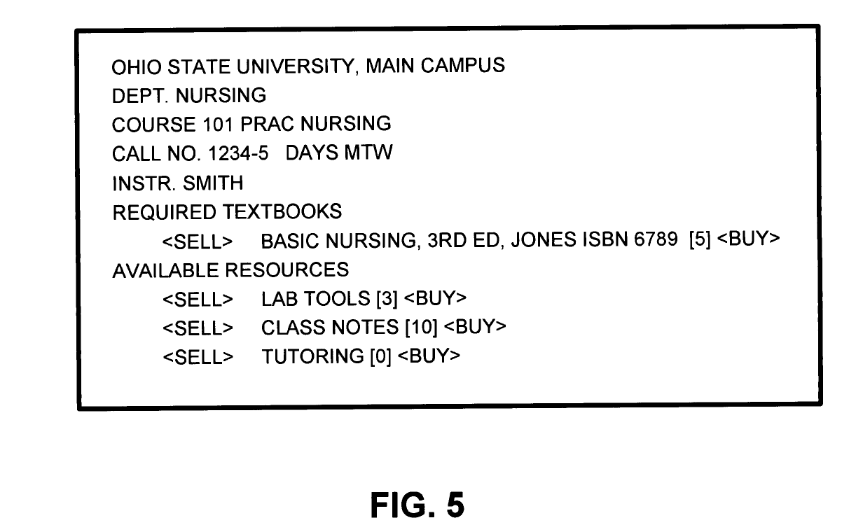

FIG. 2 shows the method for practicing the invention. A user accesses the site. The site displays a listing of schools. The user then selects a school. For the selected school, the site displays the courses/classes for the current and/or next quarter or semester. The user then selects a particular course/class. For the selected course/class, the site displays available classroom materials and services. The user then selects either sell or buy for a desired classroom material or service. FIG. 5 shows an example of a page of the site. Listed under the specific course/class are a plurality of classroom materials and services. Under “Required Textbooks,” the bracketed “5” indicates that there are five users advertising for sale the textbook. Under “Lab Tools,” the bracketed “3” indicates that there are three users advertising for sale their laboratory tools. Under “Class Notes,” the bracketed “10” indicates that there are ten users advertising for sale their class notes. Under “Tutoring,” the bracketed “0” indicates that there are no user advertising tutoring services. Using brackets to indicate the number of users offering for sale the particular items makes it convenient for a current user to determine whether there are new sellers from the last time the site was accessed. Alternatively, the site can just indicate whether there are any of these items available or not without indicating the number of sellers. The page shown in FIG. 5 is just an example and may contain more or less information as long as the classroom materials and/or services to be sold or bought are associated with a specific course or class.

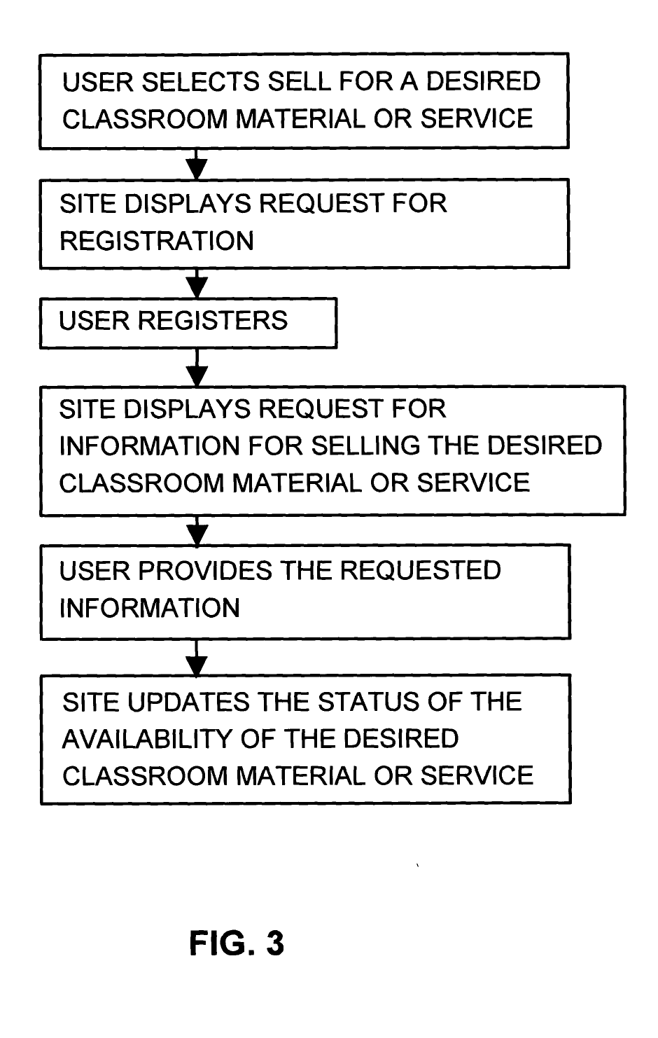

FIG. 3 shows the flow diagram if the user selects sell for the desired classroom material or service. The site displays a request for the seller to register. A previously registered seller can just enter a screen name and password to register, and, if desired, can hit a modify button to modify the seller's previously entered registration information. A new seller would have to create an unique screen name and a password, and enter their contact information. The contact information can include any of name, mailing address, email address, telephone number or any information that can be used to contact the seller. After the user registers, the site displays a request for information for selling the desired classroom material or service. If the user selected a textbook to sell, the requested information can include but is not limited to condition of book, price and any additional comments that the user would want a potential buyer to read. If the user selected lab tools to sell, the requested information can include but is not limited to condition of tools, price and any additional comments that the user would want a potential buyer to read. If the user selected class notes to sell, the requested information can include but is not limited to quarter/semester of class taken, price and any additional comments that the user would want a potential buyer to read. If the user selected tutoring to sell, the requested information can include but is not limited to price, grades of the user and any additional comments that the user would want a potential buyer to read. After the user provides the requested information, the site updates the status of the availability of the selected classroom material or service. The user may then sell or buy other items for the specific course/class or select a different course/class for the particular school. Also, the user may select a different school or just leave the site.

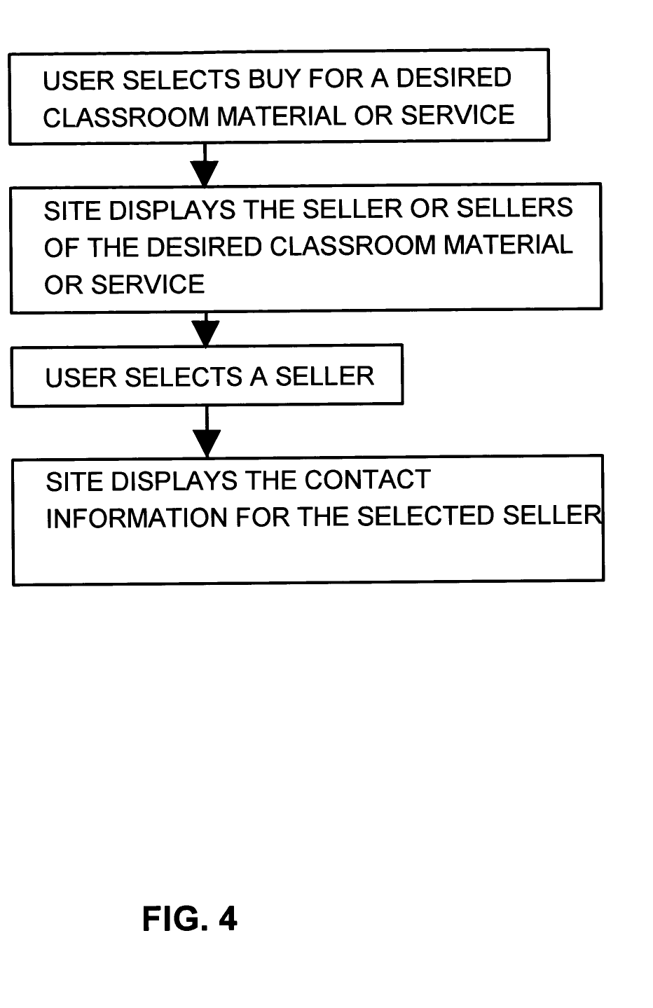

FIG. 4 shows the flow diagram if the user selects buy for a desired classroom material or service. For the selected classroom material or service, the site displays a list of screen names of sellers and can also display the information provided by the sellers for the particular classroom material or service. The user can then select one of the screen names representing a seller. The site then displays the seller's contact information.

According to another embodiment of the present invention, the user may be required to pay a fee to sell a classroom material or service. A set fee can be charged at the time the user registers at the site. Alternatively, the fee can be a percentage of the price that the classroom material or service is advertised or sold.

According to another embodiment of the present invention, the user may be required to register in order to buy a classroom material or service. A set fee can be charged at the time the user registers at the site.

According to another embodiment of the present invention, the user can select the school or course/class by entering a specific school or course/class into a search field. Further, the user can search the database of the site for courses/classes that use a specific textbook by entering the textbook's title or author or ISBN number. The user can then select to sell or buy the textbook listed under one or more courses/classes from one or more schools.

According to another embodiment of the present invention, the user can select buy or a request to buy a specific classroom material or service that does not have a seller. In this situation, the page would display to a subsequent user that a buyer wishes to buy the particular classroom material or service. The display can indicate that the particular item is requested or alternatively, indicate the number of buyers requesting the particular item. The subsequent user can then select to sell the particular classroom material or service to the requesting buyer or buyers.

According to another embodiment of the present invention, the user can save their selected courses/classes. The saved selected courses/classes can then be presented to the user during the current visit and also during subsequent visits to the site. Presenting the saved courses/classes allows the user to quickly go to a particular course/class without having to go to a listing of schools and/or listing of courses/classes. A listing includes presenting the listed items using menus such as drop down menus.

1. A method for an user on a communication network to sell or buy classroom materials and/or services, comprising:
accessing a site on the network;
selecting a school displayed on the site;
selecting a course/class associated with the selected school displayed on the site; and
selecting to sell or buy a particular classroom material or service associated with the selected course/class displayed on the site.

2. The method of claim 1, further comprising the step of providing contact information for a seller.

3. The method of claim 1, further comprising the step of registering a screen name for a seller and displaying the screen name of the seller to a buyer.

4. The method of claim 1, wherein the communication network is the Internet and the site is a web site.

5. A method for an user on a communication network to sell or buy a textbook, comprising:
displaying a web page that lists courses/classes of a school;
selecting one of the courses/classes;
displaying a web page that lists textbooks for the selected course/class; and
selecting one of the textbook to sell or buy.

6. A method for an user on a communication network to sell or buy a classroom material, comprising:
selecting a course/class at a school; and
selecting to sell or buy a classroom material for the selected course/class.

7. The method of claim 6, wherein the classroom material comprises at least one of textbooks, laboratory tools, class notes.

8. The method of claim 6, wherein the classroom material indicates the number of sellers.

9. The method of claim 6, further comprising the step of saving the user's selected course/class.

10. The method of claim 6, further comprising the step of selecting to sell or buy a classroom service for the selected course/class.
